(19) United States
(12) Patent Application Publication
(10) Pub. No.: US 2004/0081499 A1
(43) Pub. Date: Apr. 29, 2004

(54) Image recording method and image recording apparatus

(75) Inventor: Yoshiharu Sasaki, Fujinomiya-shi (JP)

Correspondence Address: YOUNG & THOMPSON, 745 SOUTH 23RD STREET 2ND FLOOR, ARLINGTON, VA, 22202

(73) Assignee: FUJI PHOTO FILM CO., LTD., MINAMI-ASHIGARA-SHI (JP)

(21) Appl. No.: 10/657,128

(22) Filed: Sep. 9, 2003

(30) Foreign Application Priority Data
Sep. 11, 2002 (JP) 2002-265585

(51) Int. Cl. B41J 2/00

(52) U.S. Cl. 400/118.2

(57) ABSTRACT

A glass substrate is fixed onto a cylindrical support member (drum), the cylindrical support member is rotated (a fast scan), a laser recording head is moved in an axial direction of the cylindrical support member (a slow scan), and a laser beam is modulated and controlled like an image through the laser recording head so that an image character is recorded on the glass substrate.

### BACKGROUND OF THE INVENTION

1. Field of the Invention

The present invention relates to an image recording method and apparatus for recording an image on a glass substrate, and more particularly to an effective image recording method and apparatus for manufacturing a color filter for a liquid crystal having a high resolution using a laser beam.

2. Description of the Related Art

The needs for recording an image on a glass substrate have conventionally been increased. In this case, there has been proposed a method of recording an image on a glass substrate by using a movable stage according to the earlier application of the applicant (for example, JP-A-2001-189913).

FIG. 11 is a plan view showing a recording apparatus according to the invention disclosed in the JP-A-2001-189913 and FIG. 12 is a front view. Inbothof the drawings, a recording apparatus 21 comprises, as a main structure thereof, a stage 27 which holds a non-flexible member 23 such as a glass substrate and is movable along a parallel surface with a recording surface 25 of the non-flexible member 23, a recording head 29 for being moved to a standby position 65 or a recording origin position 69 and recording an image on a plurality of spots formed by emitting a laser beam, a recording medium supply section 31 for supplying a recording medium (an image receiving sheet or a transfer sheet) to the non-flexible member 23 held by the stage 27, a pressurizing roller (not shown) for pressing the recording medium and hermetically bonding the recording medium to the recording surface 25 of the non-flexible member 23 and separating means (not shown) for separating the recording medium from the non-flexible member 23.

In addition to the main structure, furthermore, the recording apparatus 21 is provided with a non-flexible member supply section 33 for stacking and mounting the non-flexible member 23, a delivery-in mechanism 49 for delivering the non-flexible member 23 from the non-flexible member supply section 33 to the stage 27 which will be descried below, a discharging mechanism 51 for discharging the non-flexible member 23 having an image transferred thereto from the stage 27, and a non-flexible member receiving section 35 for stacking and mounting the non-flexible member 23 discharged by the discharging mechanism 51. Moreover, 37 (FIG. 11) denotes a discarding box for discarding a used recording medium. The recording apparatus 21 covers the outer peripheries of a recording section 39 having the stage 27 and the recording head 29 and the recording medium supply section 31 with a shielding frame 41 in respect of the safety of a laser leakage prevention.

In the case in which the recording apparatus 21 is used in order to form a black stripe for a liquid crystal or a color filter for a liquid crystal, at least the body of the recording apparatus 21, the non-flexible member supply section 33 and the non-flexible member receiving section 35 are provided in a clean room.

In the non-flexible member supply section 33, a plurality of non-flexible members 23 are stacked and mounted at a predetermined interval. Usually, the non-flexible member 23 is mounted with the recording surface 25 provided on the underside in order not to lay dust thereover.

The recording apparatus 21 has the delivery-in mechanism 49 between the non-flexible member supply section 33 and the stage 27. Moreover, the recording apparatus 21 has the discharging mechanism 51 between the stage 27 and the non-flexible member receiving section 35. The delivery-in mechanism 49 and the discharging mechanism 51 have a sucker 53 of a vacuum sucking type which serves to hold the non-flexible member 23. At least three, preferably four suckers 53 are provided. An air piping which is not shown is connected to each of the suckers 53 and a sucking source 55 such as a vacuum pump or a blower is connected to the end of the air piping. The number of the suckers may be increased depending on the size of the non-flexible member 23 if necessary.

The delivery-in mechanism 49 and the discharging mechanism 51 have the suckers 53 attached to a pedestal 57. The pedestal 57 can be reciprocated between the stage 27 and the delivery-in mechanism 49 or discharging mechanism 51 by a slide rail or a guide groove which is not shown. The pedestal 57 is driven by using a driving source such as an electric motor, an air cylinder or a hydraulic cylinder.

The body of the recording apparatus 21 comprises a controller 59 for controlling the image forming circuit of the recording head 29, the driving motor of the recording head 29, the driving motor of the stage 27, the delivery-in mechanism 49, the discharging mechanism 51 and the sucking source 55, and a power source 61 for supplying a power to the controller 59, the sucking source 55 and each driving motor. Moreover, the recording apparatus 21 connects the controller 59 to a host computer 63 through a communicating line so that image forming control and the control of the supply and discharge of the non-flexible member 23 can be carried out by the transmission and receipt of a control signal.

Next, description will be given to an operation for taking the non-flexible member 23 out of the non-flexible member supply section 33 and delivering the non-flexible member 23 into the stage 27. In the body of the recording apparatus 21, the recording head 29 is retreated from the stage 27 to the recording head standby position 65. Moreover, the stage 27 is moved to the supply position of the non-flexible member 23. The recording section 39 has a center position set to be the recording origin position 69 of the recording head 29 (FIG. 11). Furthermore, the moving range of the stage 27 includes first, second, third and fourth quadrants having the same areas as the area of the stage 27 around the recording origin position 69. In other words, the stage 27 can be moved over a double distance of a vertical and horizontal size. Consequently, the recording head 29 positioned in the recording origin position 69 can be scanned relatively in all positions on the stage 27.

The delivery-in mechanism 49 moves the pedestal 57 in an almost horizontal direction toward the upper part of the non-flexible member 23 mounted on the uppermost layer of the non-flexible member supply section 33 (FIG. 12) and stops the pedestal 57 at the upper part of the non-flexible member 23, and then moves the pedestal 57 downward, and stops the downward movement when the sucker 53 abuts on the non-flexible member 23. Subsequently, the sucking source 55 (FIG. 12) is driven to apply a negative pressure to the sucker 53 in such a state that the sucker 53 abuts on the non-flexible member 23, and the non-flexible member 23 is caused to float from a pin 45 and is adsorbed and held. In the non-flexible member 23, a surface on the opposite side of a surface adsorbed by the sucker 53 is set to be the recording surface 25. For this reason, an adsorbing track caused by the sucker 53 does not remain on the recording surface 25.

The pedestal 57 holding the non-flexible member 23 is returned to the body side of the recording apparatus 21 in a horizontal direction and is once stopped on this side of the body of the recording apparatus 21. Next, the pedestal 57 inverts the delivery-in mechanism 49 vertically and supports the non-flexible member 23 with the recording surface 25 turned upward. The pedestal 57 passes through a delivery-in opening section formed on the shielding frame 41 which is not shown and delivers the non-flexible member 23 to the upper part of the stage 27 in a support attitude.

The upper surface of the stage 27 is provided with a concave section which has an almost equal depth to the thickness of the non-flexible member 23 and takes the shape of a square seen on a plane. The non-flexible member 23 is accommodated in the concave section. Moreover, a plurality of pins which support and lift the non-flexible member 23 and can be freely moved upward and downward are erected on the bottom surface of the concave section. In the concave section 71, furthermore, an offset pin which is offset toward the opposed side surfaces and can be freely protruded is provided on each of two side surfaces which are orthogonal to each other.

The stage 27 has a plurality of sucking holes formed on the peripheral edge and bottom surface of the concave section, and the sucking hole is connected to the sucking source 55 (FIG. 12) through the air piping and the air is sucked from the sucking hole, thereby sucking and fixing the non-flexible member 23 onto the bottom surface of the concave section.

When the pedestal 57 is stopped above the stage 27 and is moved downward and the non-flexible member 23 comes in contact with a pin, the downward movement is stopped. When the pedestal 57 is stopped, the air piping is opened to the atmosphere so that the non-flexible member 23 is supported by the pin. Then, the pedestal 57 is retreated from the passage opening section of the shielding frame 41 to the outside of the body of the recording apparatus 21. The stage 27 moves the pin 73 downward, thereby mounting the non-flexible member 23 in the concave section 71. The stage 27 moves the offset pin 75 from the two orthogonal side surfaces toward the opposed side surfaces when the non-flexible member 23 comes in contact with the bottom surface of the concave section 71. Consequently, the non-flexible member 23 has two orthogonal side surfaces abutting on the two orthogonal side surfaces of the concave section so that positioning in an XY direction is carried out.

Next, the stage 27 sucks the air from the sucking hole 77 by means of the sucking source 55, thereby sucking and fixing the non-flexible member 23 to the bottom surface in the concave section 71. Consequently, the non-flexible member 23 is completely held in the stage 27.

Subsequently, an image is recorded on the non-flexible member 23 held in the stage. Then, the non-flexible member 23 is transferred to the non-flexible member receiving section 35 in reverse order to the same process.

As described above, according to the recording method in accordance with the prior invention, the transfer sheet is hermetically bonded to the non-flexible member supplied from the non-flexible member supply section onto the stage, and an image is transferred onto the transfer sheet by a laser beam to separate the transfer sheet from the non-flexible member, thereby transferring the image onto the recording surface of the non-flexible member. Consequently, an image of high picture quality can be recorded on the non-flexible member which cannot be bent, for example, the glass substrate.

However, such a planar recording apparatus has a disadvantage that the cost of the apparatus is considerably high, and furthermore, expensive components and a position control mechanism with high precision are required for obtaining the high precision.

### SUMMARY OF THE INVENTION

It is an object of the invention to eliminate the disadvantages of the planar recording apparatus and to provide a recording method and apparatus which can reduce the cost of the apparatus, and furthermore, requires neither expensive components nor a position control mechanism with high precision to obtain the high precision.

In order to achieve the object, a first aspect of the invention is directed to an image character recording method comprising the steps of fixing a glass substrate on a cylindrical support member, rotating the cylindrical support member (a fast scan), moving a laser recording head in an axial direction of the cylindrical support member (a slow scan), and modulating and controlling a laser beam like an image through the laser recording head to record an image character on the glass substrate.

A second aspect of the invention is directed to the image character recording method according to the first aspect of the invention, wherein a radius of curvature of the cylindrical support member is set within a bending permissible stress of the glass substrate.

A third aspect of the invention is directed to the image character recording method according to the second aspect of the invention, wherein the radius of curvature is 0.79 m or more.

A fourth aspect of the invention is directed to the image character recording method according to any of the first to third aspects of the invention, wherein a plurality of glass substrates are fixed onto the cylindrical support member.

A fifth aspect of the invention is directed to an image character recording apparatus comprising a cylindrical support member capable of fixing a glass substrate, a rotating device for rotating the cylindrical support member, a laser recording head which is movable in an axial direction of the cylindrical support member, and a modulating controller for modulating and controlling a laser beam transmitted from the laser recording head.

A sixth aspect of the invention is directed to the image character recording apparatus according to the fifth aspect of the invention, wherein a radius of curvature of the cylindrical support member is set within a bending permissible stress of the glass substrate.

A seventh aspect of the invention is directed to the image character recording apparatus according to the sixth aspect of the invention, wherein the cylindrical support member is a recording drum.

An eighth aspect of the invention is directed to the image character recording apparatus according to the sixth aspect of the invention, wherein the cylindrical support member is formed with a plurality of discs arranged in an axial direction.

### BRIEF DESCRIPTION OF THE DRAWINGS

FIGS. 1(a), 1(b) and 1(c) show the views showing a first embodiment of the invention, (a) being a perspective view showing a state in which a glass substrate is wound upon a cylindrical drum, (b) being a sectional view taken along A-A in FIG. 1(a), and (c) being a sectional view taken along B-B in FIG. 1(a),

FIGS. 2(a), 2(b) and 2(c) show the views showing a second embodiment of the invention, (a) being a perspective view showing a state in which a glass substrate is wound upon two discs, (b) being a sectional view taken along A-A in FIG. 2(a), and (c) being a sectional view taken along B-B in FIG. 2(a),

FIG. 3 is a view showing a specific example of a method of fixing a planar glass substrate, (a) showing a pressing method using a roller and (b) showing a method of carrying out pressing by the force of a spring,

FIG. 4 is a view showing an example of a recording pattern to be recorded on the glass substrate by the recording method, illustrating an example of a color filter for a liquid crystal,

FIG. 5 is a table showing a change in radii of curvature (m) of three kinds of glasses with a variation in a thickness (m) of the glass substrate,

FIG. 6 is a graph showing the table in FIG. 5, indicating a change in the radii of curvature (m) with a variation in the thicknesses (m) of the three kinds of glasses,

FIG. 7 is a general schematic view showing a structure according to an example of a recording apparatus for fixing a glass substrate to a cylindrical support member to carry out recording according to the invention,

FIG. 8 is an enlarged perspective view showing a recording section in FIG. 7,

FIG. 9 is a sectional view showing a glass substrate and a transfer sheet which are used in the recording apparatus illustrated in FIG. 7,

FIG. 10 is an explanatory view conceptually showing a recording process to be carried out by the recording apparatus illustrated in FIG. 7,

FIG. 11 is a plan view showing a recording apparatus disclosed in the prior invention JP-A-2001-189913 of the applicant, and

FIG. 12 is a front view showing the recording apparatus in FIG. 11.

### DESCRIPTION OF THE PREFERRED EMBODIMENTS

The invention will be described below in detail with reference to the drawings.

The invention provides a method of fixing a glass substrate onto a cylindrical support member and rotating the cylindrical support member in this state (a fast scan), and moving a laser recording head in the axial direction of the cylindrical support member (a slow scan) to modulate and control a laser beam like an image through the laser recording head, thereby recording an image character on the glass substrate.

Conventionally, it has been supposed that “the glass substrate is not bent” (a non-flexible member) as in the prior invention. Therefore, a recording operation in the bending state of the glass substrate has not been taken into consideration at all. Moreover, some specialists knew that the glass substrate can be bent to some extent but were not sufficiently aware of an advantage obtained by carrying out the recording operation in the bending state on purpose. For this reason, an attachment to a cylindrical drum has never dared to be carried out at the risk of a fragility.

However, the applicant has found that a glass substrate to be used in a color filter for a liquid crystal is sufficiently resistant to bending. Accordingly, it is possible to carry out the recording operation with the glass substrate fixed to a cylindrical support member, and furthermore, it is not necessary to provide a large-scaled apparatus as in the prior invention. Thus, the applicant has found such an advantage as to considerably reduce a cost.

The invention will be described below.

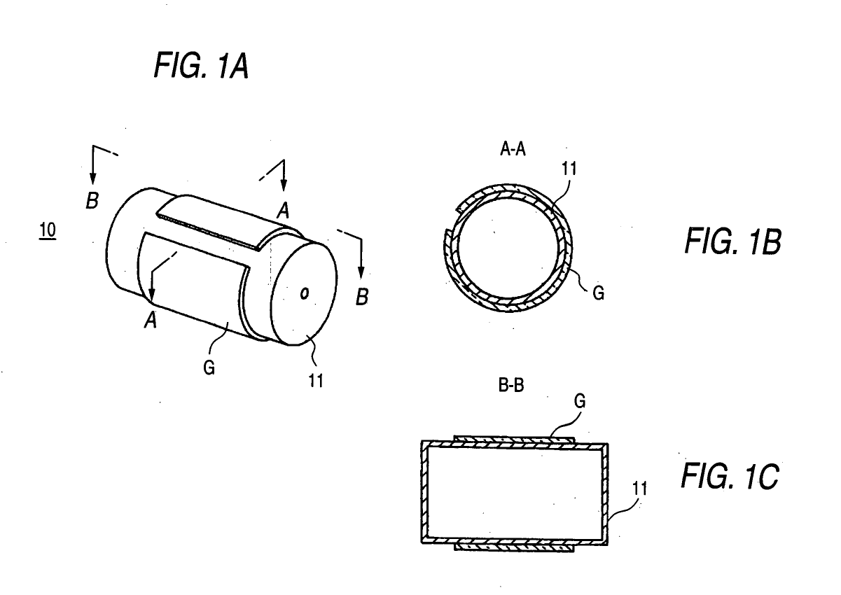

FIG. 1 is a view showing a first embodiment of the invention, (a) being a perspective view showing a state in which a glass substrate is wound upon a cylindrical drum, (b) being a section taken along A-A of FIG. 1(a), and (c) being a sectional view taken along B-B of FIG. 1(a). 11 denotes a cylindrical drum and G denotes a glass substrate. According the invention, thus, the planar glass substrate G is wound upon the cylindrical drum 11 and is thus fixed thereto. The radius of the cylindrical drum 11 and the type and thickness of the planar glass substrate G will be described below.

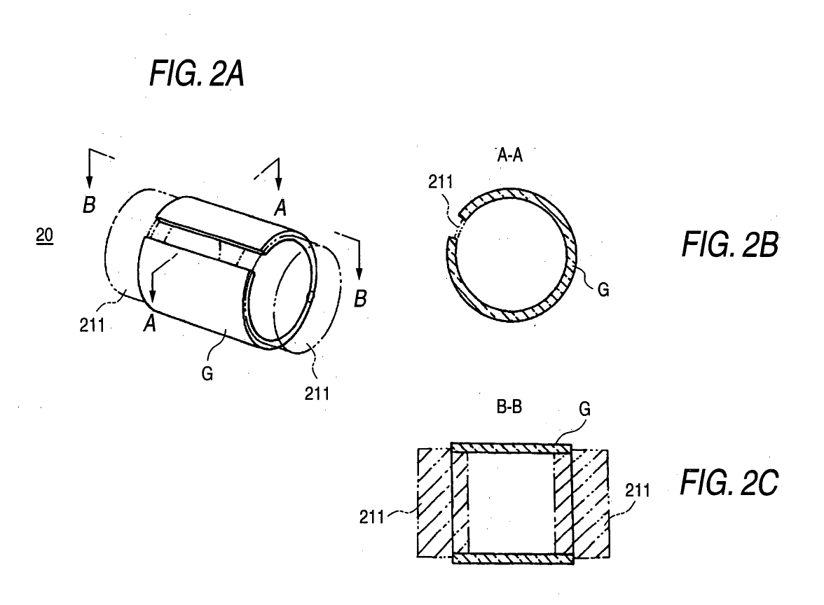

FIG. 2 is a view showing a second embodiment of the invention, (a) being a perspective view showing a state in which a glass substrate is wound upon two discs, (b) being a sectional view taken along A-A of FIG. 2(a), and (c) being a sectional view taken along B-B of FIG. 2(a). Two discs 211 and 212 are provided on both ends in an axial direction and the glass substrate G is wound upon a circumference across the two discs 211 and 212. 211 and 212 denote the discs which are provided with steps lowered inward in such a manner that the glass substrate G fixed onto the circumference is not shifted. The radii of the discs 211 and 212 and the type and thickness of the planar glass substrate G will be described below.

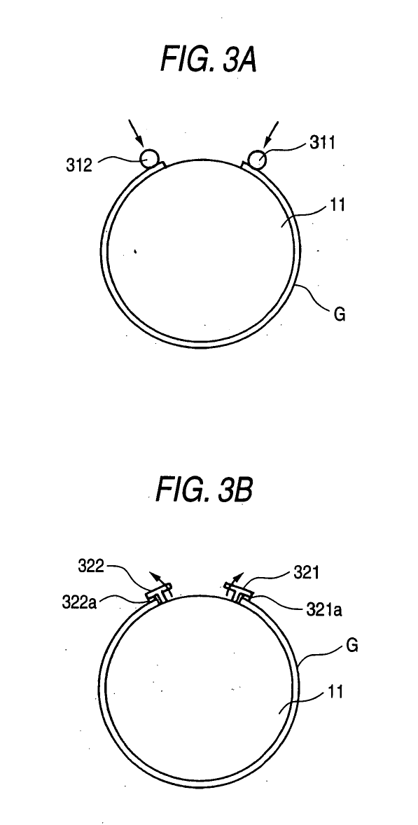

FIG. 3 is a view showing a specific example of a method of fixing the glass substrate, (a) showing a pressing method using a roller and (b) showing a method of carrying out pressing by the force of a spring.

In FIG. 3(a), 311 and 312 denote pressing rollers. The pressing rollers 311 and 312 press both ends of the glass substrate G in such a stage that the glass substrate G is fixed to the cylindrical drum 11. Moreover, the pressing roller 311 may also be used as a squeezing roller.

In FIG. 3(b), 321 and 322 denote end pressing members, each of them has one of ends which is always energized by a spring toward the cylindrical drum 11 side. An elastic member is provided in a portion coming in contact with the glass substrate G in such a manner that the glass substrate G is not broken. In fixation, the other end of each of the end pressing members 321 and 322 is pressed toward the cylindrical drum 11 side so that the end is greatly opened against a spring pressure. Therefore, it is preferable that the end of the glass substrate G should be inserted in the opening and the other end should be released.

In the method using the two discs in FIG. 2, it is preferable to use the method of FIG. 3(b) or a chucking mechanism to be utilized in a CTP by setting a contact portion with the end of the glass substrate to be an elastic member such as rubber in place of the method of carrying out pressing by means of a pressing roller in FIG. 3(a).

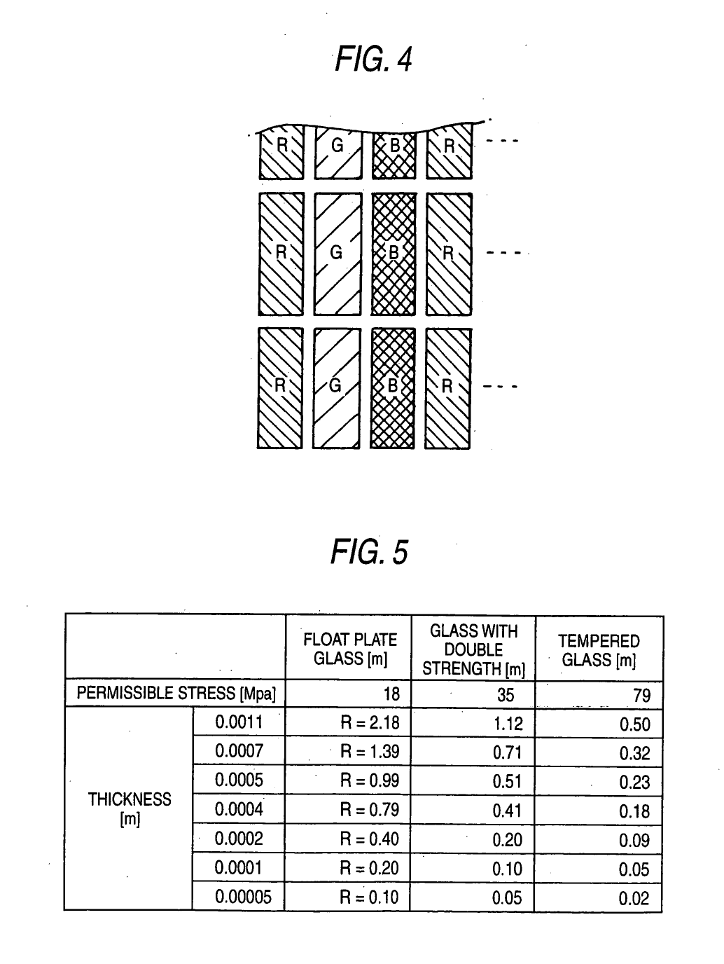

FIG. 4 shows an example of a recording pattern to be recorded on the glass substrate by the recording method, illustrating an example of a color filter for a liquid crystal.

A width of a stripe printed on the color filter for a liquid crystal is set to be 5 to 1000 μm and the width of a stripe in the color filter for a liquid crystal is set to be 3 to 300 μm and the length of the stripe is set to be 2 to 70 inches (diagonal) in a whole width, and a length of 50 to 2000 μm is set in case of a rectangular pattern. Each stripe is recorded in the same color in a longitudinal direction of the drawing (for example, R, G, B, R, G, B, R, . . . in order from the left side in the drawing) . Moreover, it is also possible to record K (black) between the stripes, thereby enhancing a contrast.

The curvature of the glass substrate to be used in the invention will be considered.

A radius R of a drum is to be set for winding to be carried out such that a glass is not broken. According to the general knowledge in the strength of materials (for example, a book [Strength of the Materials <Basic Edition> issued by Morikita Publishing Co., Ltd., written by Isohachi Oda et al., the first edition and the first impression issued in Dec. 26, 1988] pp. 98, the following has been described.

First of all, each symbol is defined as follows:

σ; Stress (a stress generated in a material when the material is bent)

E; Modulus of direct elasticity

Z; Half of thickness

R; Radius of curvature

In the present simple sectional shape, a maximum stress is generated on the surface of the material. Consequently, the following equation (1) can be obtained.

σ=E×z/R (1)

More specifically, if a modulus of direct elasticity E, a thickness 2z and a radius of curvature R in a bending state are defined, a stress σ generated on the surface of the material can be obtained from the equation (1).

Moreover, an equation (2) can be obtained from the modification of the equation (1).

R=E×z/σ (2)

This equation implies that the radius of curvature R can be obtained if the modulus of direct elasticity E and the thickness 2z of the material and the stress σ generated on the surface of the material in the bending state are defined. In other words, if the modulus of direct elasticity and the thickness are known, the radius of curvature R is determined by the stress σ applied to the material.

In order to know the degree of the glass substrate which can be bent, therefore, specific numeric values for the three elements, that is, the stress σ and the modulus of direct elasticity E of the glass and the thickness 2z of the glass substrate will be checked up.

1) Referring to the stress σ of a glass:

Referring to the breaking stress of the glass, an ordinary glass (a float plate glass in materials) has a mean breaking stress which is smaller in an edge portion than that in a plane and the value is 35 Mpa (≈360 kg/cm²).

Moreover, the edge portion of the ordinary glass has a permissible stress of 18 Mpa (≈180 kg/cm²) in consideration of a factor of safety based on a breaking probability.

Furthermore, a glass having a double strength also has a permissible stress of 35 Mpa (≈360 kg/cm²).

In addition, a tempered glass also has a permissible stress of 79 Mpa (≈810 kg/cm²).

2) Referring to the modulus of direct elasticity E of a glass:

The modulus of direct elasticity E of the glass is 7.13×10⁴ (Mpa) based on the chronological table of science.

3) Referring to the thickness 2z of a glass substrate:

A glass substrate to be usually used for a liquid crystal has a thickness of 0.7 mm.

In addition, however, a liquid crystal of a conventional type has a thickness of 1.1 mm and a glass substrate having a thickness of 0.5 mm or 0.4 mm can be expected to be used in the future. By the future development of a glass manufacturing technique or a handling technique, furthermore, it is also possible to use a very thin glass substrate having a thickness of 0.2 mm, 0.1 mm or 0.05 mm.

However, a radius of curvature at which the glass substrate can be bent is calculated by each type and thickness based on the values (σ, E, z) and the equation (2).

A table shown in FIG. 5 indicates the radii of curvature (m) of three kinds of glass substrates which are obtained with a change in a thickness (m). In FIG. 5, the thickness of the glass substrate to be usually used for a liquid crystal is 0.7 mm as described above. Therefore, it is sufficient that a cylindrical drum to be used has a radius of 1.39 m or more in a combination with an ordinary (float plate) glass.

In case of the glass having a double strength, moreover, it is sufficient that a cylindrical drum has a radius of 0.71 m or more.

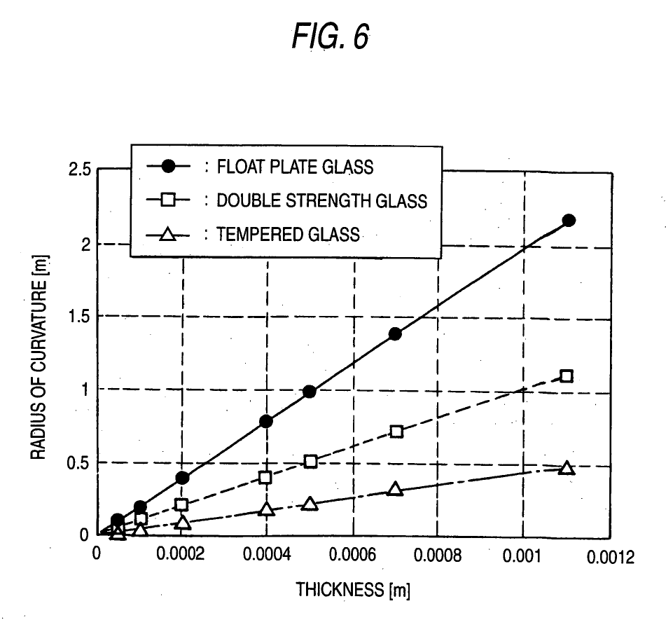

FIG. 6 is a graph in which the table shown in FIG. 5 is generalized for easy understanding.

In FIG. 6, since the glass substrate to be usually used for a liquid crystal has a thickness of 0.7 mm as described above, it is sufficient that the cylindrical drum to be used has a radius of 1.39 m or more. In case of a glass having a double strength and a thickness of 0.7 mm, similarly, it is sufficient that the cylindrical drum has a radius of 0.71 m or more.

Any of the values within the above range is taken depending on the setting of a factor of safety.

Based on the result described above, a cylindrical drum having a radius of 1.39 m (a drum circumference of 8.73 m) was used. Although the size of the drum is increased, eight ordinary glasses can be mounted on the drum if each of them has a size of 1 m×1 m in length and breadth, for example. Consequently, a productivity can be greatly enhanced. As a matter of course, a manufacturing cost is set to be approximately one-tenth to one-twentieth of the prior invention.

In case of the glass having a double strength, moreover, a cylindrical drum having a radius of 0.71 m (a drum circumference of 4.4 m) is used. Consequently, the size of the drum could be reduced. Four glasses having a size of 1 m×1 m in length and breadth could be mounted on the drum.

A recording head to be used may include a plurality of spots. A recording medium may be formed by a photon mode material having no photothermal converting layer in addition to a heat mode.

In order to fix a transfer film, (1) a sucking hole or a sucking groove provided in the position of a glass edge portion on a cylindrical drum is utilized. Alternatively, (2) a heat roller (in case of the cylindrical drum) or a lamination using oven hot air is utilized or (3) a chucking mechanism (JP-A-11-157155 developed by the applicant) uses a chucking cam formed with cam acting positions having different radius distances provided in at least three places, and glass substrates having different thicknesses can also be stably fixed by using the chucking mechanism, which is convenient.

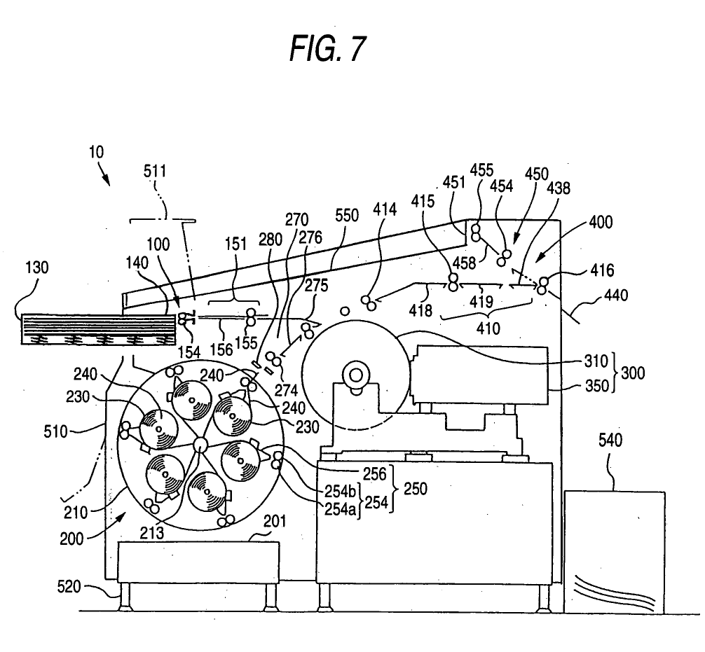

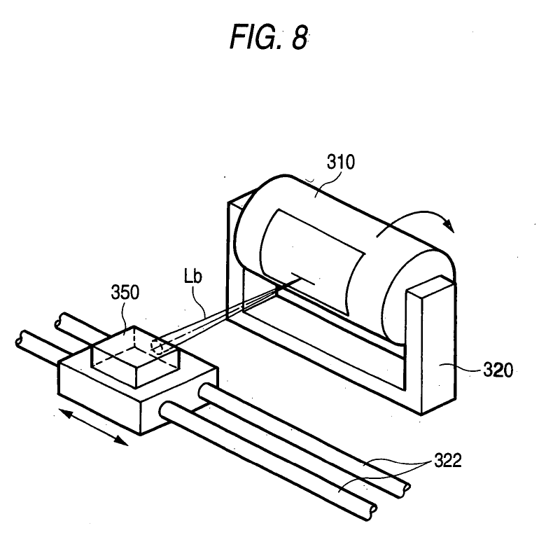

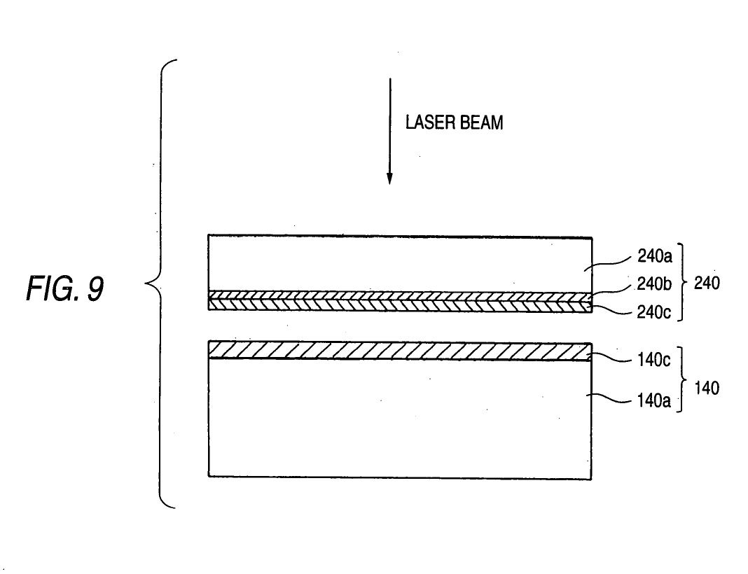

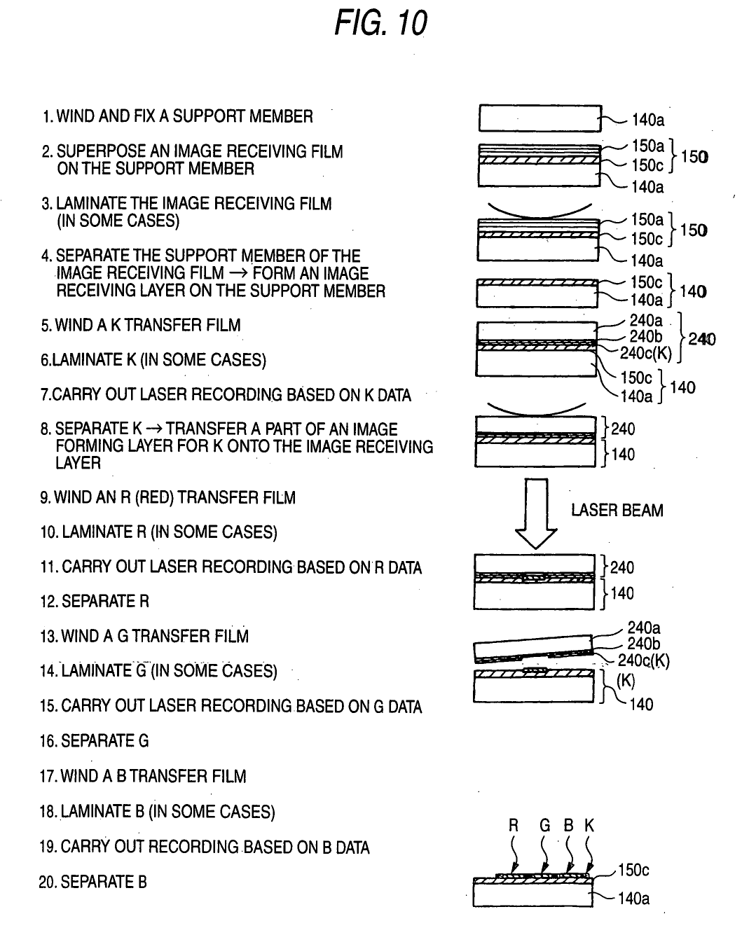

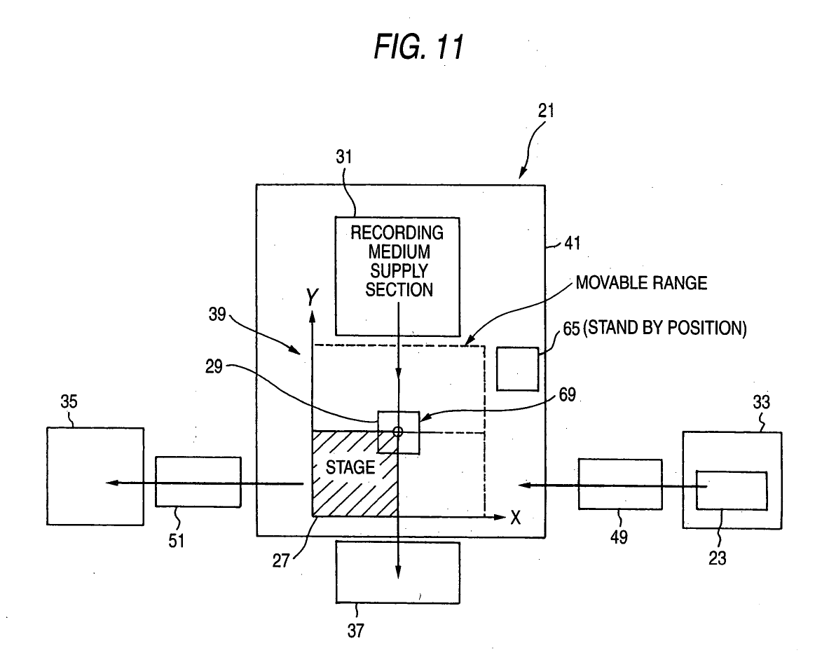

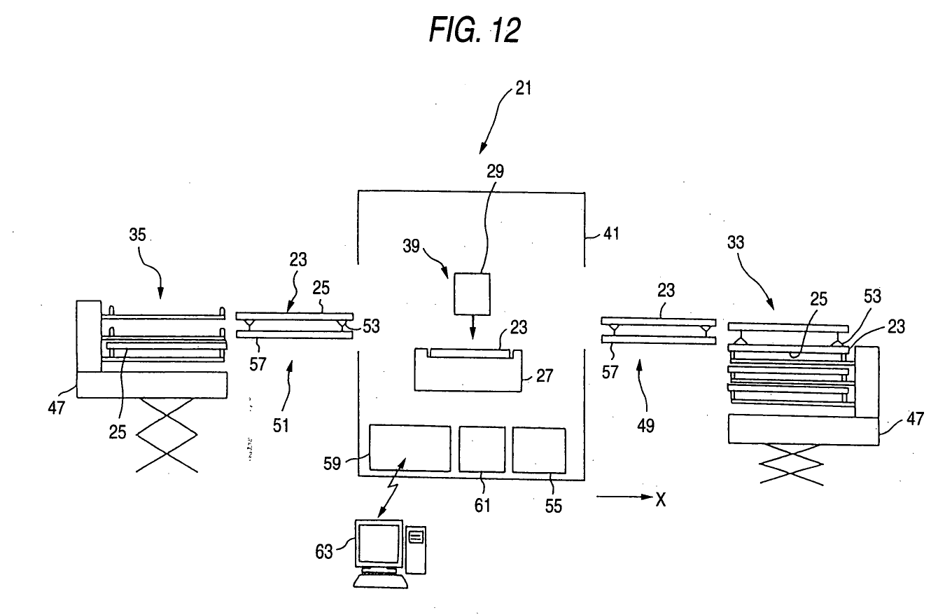

FIG. 7 is a general schematic view showing a structure according to an example of a recording apparatus for fixing a glass substrate to the cylindrical support member to carry out recording, FIG. 8 is an enlarged perspective view showing a recording section in FIG. 7, FIG. 9 is a sectional view showing the glass substrate and a transfer sheet which are used in the recording apparatus of FIG. 7, and FIG. 10 is an explanatory view conceptually showing a recording process to be carried out by the recording apparatus in FIG. 7.

As shown in FIG. 7, a recording apparatus 10 comprises a glass substrate supply section 100, a transfer sheet supply section 200, a recording section 300 and a discharging section 400. Moreover, the recording apparatus 10 has a surface covered with a body cover 510 and is supported by a leg section 520.

In the recording apparatus 10, the glass substrate supply section 100 supplies a glass substrate to the recording section 300. Moreover, the transfer sheet supply section 200 can supply plural kinds of transfer sheets and one of the plural kinds of transfer sheets can be selectively supplied to the recording section 300. In the recording section 300, a transfer sheet is further superposed and wound upon a glass substrate wound upon a drum 310 to be a recording medium fixing member. A recording medium having the transfer sheet superposed on the glass substrate is subjected to laser exposure based on information about an image to be recorded. The toner of the transfer sheet in a portion heated by the laser exposure is bonded and transferred to the glass substrate due to a deterioration in an adhesion, melting or sublimation. Thus, an image is formed on the glass substrate. Furthermore, the toners of the transfer sheets having a plurality of different colors (for example, R (red), G (green), B (blue) and K (black)) are stuck to the same glass substrate. Consequently, a color image can be formed on the glass substrate. This can be achieved by sequentially exchanging an exposed transfer sheet for a transfer sheet having another color to carry out the laser exposure with the glass substrate wound upon the drum 310.

The glass substrate having an image formed thereon is discharged through the discharging section 400 and is taken out of the recording apparatus. The recording apparatus 10 has been schematically described above.

Next, the glass substrate supply section 100, the transfer sheet supply section 200, the recording section 300 and the discharging section 400 will be sequentially described below.

The glass substrate supply section 100 has a glass substrate housing cassette 130. The glass substrate housing cassette 130 has a spring provided on a bottom surface and pushes the glass substrate up to a supply port. Consequently, only an uppermost glass substrate is always taken out of the supply port by the rotation of a taking pick-up roller (not shown), and is transferred to a roller 154 side for delivery.

A glass substrate push-out mechanism may be provided in the glass substrate housing cassette 130 on the opposite side of the supply port to push only the uppermost glass substrate toward the supply port side.

Alternatively, a sucker delivery mechanism described in the prior invention may be used.

The glass substrate supply section 100 further has a glass substrate delivery section 151. The glass substrate delivery section 151 has a motor (not shown), a belt or chain for a driving transmission (not shown), delivery rollers 154 and 155, a support guide 156, and a detecting sensor (not shown) for detecting the end point of a glass substrate.

Each of the delivery roller 154 and the delivery roller 155 has a pair of rollers. By such a driving mechanism, a glass substrate 140 can be transferred to the recording section 300 or returned from the recording section 300.

First of all, the glass substrate 140 is pulled out by the driving mechanism such as a motor with the tip portion of the glass substrate housing cassette 130 interposed between the delivery rollers 154. Consequently, one uppermost glass substrate 140 is reeled out of the glass substrate housing cassette 130. The glass substrate 140 is further interposed between the delivery rollers 155 and is guided and delivered by the support guide 156.

Next, the transfer sheet supply section 200 will be described.

The transfer sheet supply section 200 has a rotating rack 210. The rotating rack 210 is rotated around a rotating shaft 213 as will be described below. Moreover, the rotating rack 210 accommodates a plurality of (six in the drawing) transfer sheet rolls 230 which are arranged “radially” around the rotating shaft 213.

Each transfer sheet roll 230 has a core, a transfer sheet 240 wound thereupon and a flange (not shown) inserted from both sides of the core. Each of the transfer sheet rolls 230 is rotatably held around each core. The outside diameter of the flange is set to be larger than the diameter of the transfer sheet portion so that the transfer sheet portion can be prevented from collapsing.

Each transfer sheet 240 has a support layer 240a, a photothermal converting layer 240b and a toner layer 240c, and the photothermal converting layer 240b and the toner layer 240c are sequentially provided on the support layer 240a as shown in FIG. 9. For the support layer 240a, it is possible to select any of general support member materials through which a laser beam can be transmitted. For example, it is possible to use a PET (polyethylene terephthalate) base, a TAC (triacetylcellulose) base, and a PEN (polyethylene naphthalate) base.

The photothermal converting layer 240b contains a photothermal converting substance, a binder and a mat agent if necessary, and further contains other components if necessary. The photothermal converting substance has the function of converting an optical energy which is irradiated into a heat energy. In general, the photothermal converting substance is a dye capable of absorbing a laser beam (containing a pigment and so forth). In the case in which image recording is to be carried out by an infrared laser, it is preferable that an infrared absorbing dye should be used as the photothermal converting substance. Examples of the dye include a black pigment such as carbon black, a macrocyclic compound pigment having an absorption from a visible region to a near-infrared region, for example, phthalocyanine or naphthalocyanine, an organic dye to be used as a laser absorbing material for high density laser recording such as an optical disc (a cyanine dye such as an indorenine dye, an anthraquinone based dye, an azulene based pigment and a phthalocyanine based dye), and an organometallic compound dye such as a dithiolnickel complex. In particular, the cyanine based dye has a high absorption coefficient for a light in an infrared region. When the cyanine based dye is used as the photothermal converting substance, therefore, the thickness of the photothermal converting layer can be reduced. As a result, the recording sensitivity of a thermal transfer sheet can be more enhanced, which is preferable.

For the photothermal converting substance, it is also possible to use a granular metallic material such as photographic silver and an inorganic material in addition to the dye. More specifically, it is also possible to use any substance for converting an optical energy into a heat energy, for example, carbon, a black substance, an infrared absorbing dye and a specific wavelength absorbing substance.

For the toner layer 240c to be the image forming layer, for example, a toner sheet having each of colors including black (K), red (R), green (G) and blue (B) is prepared. In addition, it is also possible to use a transfer sheet having a special color such as gold, silver, orange, gray or pink.

The image receiving layer 140c has the function of receiving a toner to be transferred. However, the image receiving layer 140c is not an indispensable layer but can be omitted if the surface of the support member has such a feature that a transfer can easily be carried out.

In the transfer sheet roll 230, the toner layer 240c is wounded to be placed on the outside of the support layer 240a (The transfer sheet roll thus wound will be hereinafter referred to as an “outward wound” transfer sheet roll”). The toner layer 240c has a toner ink and the toner ink is transferred to the glass substrate by the laser exposure as will be described below.

FIG. 7 shows the case in which six transfer sheet rolls 230 are accommodated in the rotating rack 210. As six kinds of transfer sheets, for example, it is possible to use transfer sheets having four colors of black, red, green and blue and transfer sheets having two special colors (for example, gold and silver).

The rotating rack 210 further has a transfer sheet reeling mechanism 250 corresponding to each of the transfer sheet rolls 230, and the transfer sheet reeling mechanism 250 is constituted by a feed roller 254 and a support guide 256. In the drawing, six transfer sheet reeling mechanisms 250 are provided. The feed roller 254 has rollers 254a and 254b. The roller 254a is connected to a motor by a gear mechanism and is driven by a motor as will be described below. The roller 254a can interpose a transfer sheet 240 together with the roller 254b by predetermined pressure. The roller 254b is rotated in a reverse direction to the rotation of the roller 254a to deliver the transfer sheet 240. The transfer sheet 240 can be interposed between the rollers 254a and 254b and can be thus fed or returned. Moreover, the transfer sheet roll 230 is rotated with the delivery of the transfer sheet 240.

By the transfer sheet reeling mechanism 250 having such a structure, the transfer sheet 240 is supplied to the recording section 300. In a state in which the tip of the transfer sheet 240 is interposed between the feed rollers 254, the feed roller 254 is driven by the driving mechanism such as a motor. By the driving operation, the transfer sheet 240 is reeled out. Moreover, the transfer sheet 240 is further cut to have a predetermined length in a transfer sheet delivery section 270 which will be described below and is thus supplied to the recording section 300.

As described above, the rotating rack 210 accommodating the transfer sheet rolls 230 can selectively supply a desirable kind of transfer sheet 240 to the transfer sheet delivery section 270.

The transfer sheet supply section 200 further has the transfer sheet delivery section 270. The transfer sheet delivery section 270 has a motor (not shown), a belt or chain for a driving transmission (not shown), delivery rollers 274 and 275, a guide 276, a transfer sheet cutting section 280, and a detecting sensor (not shown) for detecting the end of the transfer sheet. Each of the delivery rollers 274 and 275 has a pair of rollers. The rollers 274 and 275 are connected to a motor through a belt or chain for a driving transmission and are driven by the motor to deliver the transfer sheet 240.

By such a driving mechanism, the transfer sheet 240 can be sent to or returned from the recording section 300. Moreover, the transfer sheet 240 thus delivered is cut to have a predetermined length by a transfer sheet cutting section 280. For the measurement of the length of the transfer sheet 240, a detecting sensor is utilized. The end of the transfer sheet 240 is detected by the detecting sensor to take the number of rotations of the motor into consideration so that the length can be measured. The transfer sheet 240 is cut to have a predetermined length based on the result of the measurement and is thus supplied to the recording section 300. The transfer sheet cutting section 280 has a cutter, a support section and a guide which are not shown.

As described above, the transfer sheet supply section 200 reels and cuts a part of the transfer sheet roll 230, thereby supplying the transfer sheet 240 having a predetermined length to the recording section 300.

When the transfer sheet 240 is consumed, it is necessary to remove the used transfer sheet roll 230 and to exchange the used transfer sheet roll 230 for the new transfer sheet 240.

The transfer sheet roll 230 can be exchanged by opening a cover 511. In this case, the rotating rack 210 is rotated to move the transfer sheet roll 230 to be an exchange object to a predetermined exchange position corresponding to the cover 511. On the other hand, the glass substrate housing cassette 130 is also exchanged by opening the cover 511.

Next, the recording section 300 will be described.

The recording section 300 has a drum 310. As shown in FIG. 8, the drum 310 has a hollow and cylindrical shape and is rotatably held by a frame 320. In the recording apparatus 10, the rotating direction of the drum 310 is set to be a fast scanning direction. The drum 310 is coupled to the rotating shaft of a motor and is rotated by a motor. A plurality of hole sections are formed on the surface of the drum 310. The hole sections are connected to a sucking device such as a blower or a vacuum pump which is not shown.

When the glass substrate 140 and the transfer sheet 240 are mounted on the drum 310 to operate the sucking device, these sheets are adsorbed onto the drum 310.

Moreover, the drum 310 has a plurality of groove sections (not shown) and the groove sections are provided on a straight line in parallel with the rotating shaft of the drum 310. Furthermore, a plurality of separating clicks (not shown) are provided on a straight line in parallel with the rotating shaft of the drum 310 above the drum 310.

In addition, the recording section 300 has a recording head 350. The recording head 350 can emit a laser beam Lb. The toner ink of the transfer sheet 240 in a position in which the laser beam Lb is irradiated is transferred onto the surface of the glass substrate 140. Moreover, the recording head 350 can be moved rectilinearly in a parallel direction with the rotating shaft of the drum 310 along a guide rail 322 by a driving mechanism which is not shown. In the recording apparatus 10, the moving direction is set to be a slow scanning direction. Accordingly, a desirable position on the transfer sheet 240 covering the glass substrate 140 can be subjected to laser exposure by a combination of the rotating motion of the drum 310 and the rectilinear movement of the recording head 350. Accordingly, the transfer sheet 240 is scanned by the laser beam Lb for drawing to carry out the laser exposure over only a corresponding position based on image information. Consequently, a desirable image can be transferred onto the glass substrate 140.

Next, description will be given to an operation for winding the glass substrate 140 and the transfer sheet 240 onto the drum 310.

Two kinds of sheets including the glass substrate 140 and the transfer sheet 240 are wound upon the drum 310. The glass substrate 140 supplied by the glass substrate supply section 100 is first wound upon the drum 310. For the fixation of the glass substrate 140, the roller pressing method described in FIG. 2(a) or the spring force pressing method in FIG. 2(b) is employed. Moreover, a plurality of hole sections (not shown) are formed on the surface of the drum 310 and the glass substrate 140 is sucked by the sucking device (not shown). Consequently, the glass substrate 140 can be adsorbed onto and wound upon the drum 310 with the rotation of the drum 310.

Next, one transfer sheet 240 supplied from the transfer sheet supply section 200 is wound upon the glass substrate 140. The two kinds of sheets, that is, the glass substrate 140 and the transfer sheet 240 have sizes which are different from each other, and the transfer sheet 240 is larger than the glass substrate 140 in both longitudinal and transverse directions. Accordingly, the transfer sheet 240 is adsorbed onto the drum 310 by a larger portion than the glass substrate 140. The transfer sheet 240 is adsorbed onto and wound upon the drum 310 with the rotation of the drum 310.

The glass substrate 140 and the transfer sheet 240 which are wound upon the drum 310 are present with the toner layer 240c of the transfer sheet 240 coming in contact with the image receiving layer 140c of the glass substrate 140. The toner ink of the toner layer 240c having such a positional relationship is subjected to the laser exposure by the recording head 350 and is thus transferred onto the glass substrate 140 as described above. The transfer sheet 240 which has completed a transfer operation is separated from the drum 310.

Next, the separating operation will be described.

First of all, the drum 310 is rotated to a predetermined position for a separation. Then, the position of the tip portion of the separating click is moved from a standby position in which the tip portion does not come in contact with the drum 310 to a position in which the tip portion comes in contact with the drum 310. In the movement, the tip portion of the separating click is prevented from coming in contact with the transfer sheet 240. With the rotation of the drum 310, the separating click is relatively moved over the drum 310 in a circumferential direction along the surface of the drum 310. The tip portion of the separating click is moved relatively over the surface of the drum 310 along the shape of the groove portion and thus gets into the underside of the transfer sheet 240. The transfer sheet 240 is moved along the upper surface of the separating click. The transfer sheet 240 is separated from the drum 310.

The separating click is further lifted in such a separating direction from the drum 310 before coming in contact with the glass substrate 140 and is moved up to the standby position. The tip portion of the transfer sheet 240 is separated and the drum 310 is subsequently rotated so that the transfer sheet 240 is further separated from the drum 310 and the glass substrate 140. In this case, the glass substrate 140 is maintained to be adsorbed onto the drum 310 by the sucking force of the sucking device. Therefore, only the transfer sheet 240 can be separated.

The transfer sheet 240 separated by the above operation is further discharged to the outside of the apparatus through a discharging section 400 which will be described below.

Next, the transfer sheet 240 having another color is wound upon the glass substrate 140 wound upon the drum 310 in the procedure described above. By the operation described above, then, the toner ink of the transfer sheet 240 is transferred onto the glass substrate 140 by laser exposure and the transfer sheet 240 is then separated and discharged.

The same operation is repeated for plural predetermined kinds of transfer sheets 240. For example, the operation is repeated for four kinds of transfer sheets 240 of K, R, G and B. Thus, a color image is transferred onto the glass substrate 140.

Finally, the glass substrate 140 having plural kinds of toner inks thus transferred thereto is separated. The glass substrate 140 is separated in the same manner as the separation of the transfer sheet 240. In this case, the separating click approaches a plurality of groove portions to separate the glass substrate 140 from the drum 310. Moreover, it is possible to utilize the same separating click as that in the separation of the transfer sheet 240. Consequently, a structure can be simplified. Accordingly, the reliability of a machine can be enhanced.

The glass substrate 140 separated as described above is discharged to the discharging section 400.

Next, the discharging section 400 will be described.

The discharging section 400 has a sheet common delivery section 410, a transfer sheet discharging section 440 and a glass substrate discharging section 450.

The sheet common delivery section 410 has a motor (not shown), a belt or chain for a driving transmission (not shown), delivery rollers 414, 415 and 416, support guides 418 and 419, and a detecting sensor (not shown). Moreover, the sheet common delivery section 410 further has a movable guide section and is constituted by a guide plate 438 and a driving mechanism which is not shown. The guide plate 438 can be moved by a driving mechanism between two positions which will be described below.

The transfer sheet discharging section 440 serves to discharge the processed transfer sheet 240 to a transfer sheet collecting box 540.

The glass substrate discharging section 450 has a glass substrate discharging port 451, rollers 454 and 455, and a guide 458. The glass substrate 140 having an image transferred thereto is discharged to a tray 550 through the glass substrate discharging section 450.

Each of the delivery rollers 414, 415, 416, 454 and 455 is constituted by using two rollers in pairs in the same manner as other delivery rollers. The glass substrate 140 and the transfer sheet 240 are interposed between the two rollers to carry out a rotation, and they can be thus delivered.

The discharging section 400 having such a mechanism discharges the glass substrate 140 and the transfer sheet 240 in the following operations.

First of all, the discharge of the transfer sheet 240 will be described.

In the recording section 300, the transfer sheet 240 which is subjected to laser exposure and is thus unnecessary is separated from the drum 310 as described above. The transfer sheet 240 thus separated is supported by the separating click, the support guides 418 and 419, and the guide plate 438, and is interposed and transmitted by the delivery rollers 414, 415 and 416 and is thus delivered.

Next, the discharge of the glass substrate 140 will be described.

The glass substrate 140 is processed by transferring the toner ink in the recording section 300 and is then separated from the drum 310 as described above. The glass substrate 140 thus separated is supported by the separating click, the support guides 418 and 419, and the guide plate 438, and is interposed and transmitted by the delivery rollers 414, 415 and 416 and is thus delivered.

The sheet common delivery section 410 is common to that in the case in which the transfer sheet 240 is discharged and a structure can be more simplified than that in the case in which a delivery section is provided for each sheet. In the sheet common delivery section 410, the transfer sheet 240 is delivered with the toner layer provided on the lower side and the glass substrate 140 is delivered with the image receiving layer provided on the upper side. Accordingly, even if the glass substrate 140 and the transfer sheet 240 are sequentially delivered by utilizing the same delivery path, there is no possibility that an image formed on the image receiving layer of the glass substrate 140 might be contaminated.

The glass substrate 140 is delivered by the delivery rollers 414, 415 and 416 and is once discharged to the outside of the apparatus. The glass substrate 140 is not wholly discharged to the outside. In a state in which the rear end of the glass substrate 140 is present on the guide plate 438 and is interposed by the delivery rollers 416, the driving operation of the motor is once stopped. Then, the motor is reversely rotated to return the glass substrate 140 in the direction of the glass substrate discharging port 451. More specifically, a “switch back” operation is carried out. The timing of the stoppage of the driving operation is determined by the signal of the detecting sensor. The detecting sensor detects that the rear end of the glass substrate 140 passes through the position of the detecting sensor. Then, when the glass substrate 140 is delivered to reach a predetermined position, the driving operation of the motor is stopped.

The predetermined position implies a position in which the rear end of the glass substrate 140 is present on the guide plate 438 and is interposed between the delivery rollers 416. It is possible to decide whether the glass substrate 140 is moved over a predetermined distance to reach the position depending on the number of rotating pulses of the motor on a rear end detecting point which is obtained by the detecting sensor.

The guide plate 438 of the movable guide section is driven by a driving mechanism which is not shown and can be moved between a broken line/solid line shown in the drawing. By the driving mechanism, the guide plate 438 is moved. Then, the stopped motor is reversely rotated so that each of the delivery rollers 416, 454 and 455 is driven in a reverse direction. By the reverse rotation, the glass substrate 140 is returned. Thereafter, the glass substrate 140 is further supported on the guide 458 and is delivered by the delivery rollers 454 and 455, and is thus transmitted to the tray 550. The glass substrate transmitted to the tray 550 is taken out of the recording apparatus 10 and is then subjected to an additional processing in an image transfer section in another stage as described above. Consequently, printing is carried out over any printing paper.

The operation is controlled by a control section (not shown).

The control section controls the glass substrate supply section 100, the transfer sheet supply section 200, the recording section 300 and the discharging section 400. The control section controls a driving section having a motor in each of the sections. In the recording section 300, particularly, an air section such as a sucking device and an image processing section for processing image data are further controlled. Moreover, the driving section of the transfer sheet supply section 200 has two driving systems, that is, a rotation driving system of the rotating rack 210 and a sheet delivery driving system for providing the transfer sheet 240 from the transfer sheet roll 230 to the drum 310. Referring to the motor driving operation of the sheet delivery driving system, a driver for motor driving is shared for a plurality of transfer sheet reeling mechanisms as described above. A driving circuit system is simplified.

As shown in FIG. 9, the glass substrate 140 has a glass support layer 140a and an image receiving layer 140c thereon. In the glass substrate housing cassette 130, therefore, the image receiving layer 140c is stacked to be placed on the outside of the support layer 140a.

By the recording apparatus 10, a desirable color image can be formed on the glass substrate 140. Description will be given to an operation procedure in the case in which a color image is to be formed by four colors of K, R, G and B.

As shown in FIG. 10, at a step 1, the glass substrate supply section 100 (FIG. 7) takes one glass substrate 140 from the glass substrate housing cassette 130 and supplies the same glass substrate 140 to the drum 310 (FIG. 8), and the glass substrate 140 is wound upon the drum 310.

At a step 2, an image receiving film 150 is superposed on the glass substrate 140a. The image receiving film 150 is constituted by a support member 150a and an image receiving layer 150c provided separably on the support member 150a. In this case, consequently, the image receiving layer 150c of the image receiving film 150 is superposed on the glass substrate 140a opposite thereto. In some cases, the step 2 is omitted.

At a step 3, the image receiving film support member 150a side is pressed by means of a pressing (and at the same time, heating in some cases) roller in the state in which the image receiving film 150 is superposed on the glass substrate 140a, and air is thus removed from the superposed portion. Consequently, the image receiving layer 150c and the glass substrate 140a are hermetically bonded to each other. In some cases, the step 3 is omitted.

At a step 4, when the image receiving film support member 150a is separated, the image receiving layer 150c of the image receiving film remains on the glass substrate 140a so that the image receiving layer 150c (which is the same as 140c in FIG. 9) is formed on the support member 150c. Thus, the glass substrate 140 having an image receiving layer (which will be hereinafter referred to as a glass substrate) is obtained.

At a step 5 in FIG. 10, next, the transfer sheet supply section 200 (FIG. 7) supplies the black (K) transfer sheet 240 to the glass substrate 140 disposed on the drum 310.

When the rotating rack 210 of the transfer sheet supply section 200 is rotated, the black transfer sheet roll 230 is moved to a position opposed to the transfer sheet delivery path 270. The transfer sheet 240 is provided by reeling and cutting a part of the outward wound transfer sheet roll 230 and is wound upon the drum 310. At this time, the tip of the transfer sheet 240 reeled from the transfer sheet roll 230 is positioned in the vicinity of a cutter 280 provided on the outside of the rotating rack 210. In this case, when the transfer sheet 240 is supplied, the transfer sheet reeling mechanism 250 can reversely rotate the feed roller 254 to store the tip portion of the transfer sheet roll 230 on the inside of the outer peripheral portion of the rotating rack 210. Also in this case, the feed roller 254 holds the tip portion.

At a step 6 in FIG. 10, heating and pressurization are carried out to laminate the transfer sheet 240. In some cases, the laminating step is omitted.

At a next step 7, an image is transferred and output onto the glass substrate 140 based on image data which are previously given. The given image data are further color separated into an image having each color, and laser exposure is carried out based on the image data for each color which are color separated. Based on the image data for each color which are obtained by the color separation, the recording head 350 irradiates a laser beam spot Ls for drawing on the transfer sheet 240. The toner ink of the transfer sheet 240 is transferred to the glass substrate 140 so that an image is formed on the glass substrate 140.

At a step 8, when the (K) transfer film 240 is separated, a (K) transfer film portion on which the laser beam is irradiated remains on the glass substrate 140 so that a non-irradiated portion is discharged together with the (K) transfer film 240. The transfer sheet 240 separated from the drum 310 is discharged to the transfer sheet collecting box 540 through the discharging section 400.

It is decided whether the transfer is ended for the transfer films 240 having all the colors, that is, red (R), green (G) and blue (B). In the case in which the transfer film 240 of another kind is to be supplied, the processings of the steps 5 to 8 are repeated. In other words, the operations of the steps 9 to 20 are repeated for the transfer films 240 having the colors of red (R), green (G) and blue (B). As a result, the toner inks K, R, G and B of the transfer films having four colors are transferred to one glass substrate 140 and a color image is formed on the glass substrate 140.

When the processing is completed, it is decided that the laser exposure for the final transfer sheet 240 is ended.

Then, the glass substrate 140 is separated from the drum 310. The glass substrate 140 thus separated is discharged to the tray 550 with the switch back operation through the discharging section 400.

As described above, according to the invention, the glass substrate is fixed onto the cylindrical support member to rotate the cylindrical support member (a fast scan) and to move the laser recording head in the axial direction of the cylindrical support member (a slow scan). Thus, a laser beam is modulated and controlled like an image through the laser recording head to record an image character on the glass substrate. Consequently, the following advantages a to c can be obtained.

a. The manufacturing cost of the drum can be reduced still more than that of a planar recording apparatus according to the prior invention (1/10 to 1/20 of the prior invention).

b. The cost can be reduced and high precision can be obtained.

c. A CTP (Computer To Plate) and a DDCP device which have conventionally been used in a printing field can exactly be applied. Therefore, a development period/a development cost can be lessened.

What is claimed is:

1. An image character recording method comprising the steps of fixing a glass substrate on a cylindrical support member, rotating the cylindrical support member (a fast scan), moving a laser recording head in an axial direction of the cylindrical support member (a slow scan), and modulating and controlling a laser beam like an image through the laser recording head to record an image character on the glass substrate.

2. The image character recording method according to claim 1, wherein a radius of curvature of the cylindrical support member is set within a bending permissible stress of the glass substrate.

3. The image character recording method according to claim 2, wherein the radius of curvature of an ordinary glass is 1.39 m or more.

4. The image character recording method according to any of claims 1 to 3, wherein a plurality of glass substrates are fixed onto the cylindrical support member.

5. An image character recording apparatus comprising a glass substrate housing cassette for superposing a plurality of glass substrates and accommodating them, a cylindrical support member capable of fixing the glass substrate, a glass substrate delivery mechanism for taking out the glass substrate in an uppermost part of the glass substrate housing cassette and delivering the same glass substrate onto the cylindrical support member, a glass substrate fixing mechanism for fixing the glass substrate onto the cylindrical support member, a rotating device for rotating the cylindrical support member, a laser recording head which is movable in an axial direction of the cylindrical support member, and a modulating controller for modulating and controlling a laser beam transmitted from the laser recording head.

6. The image character recording apparatus according to claim 5, wherein a radius of curvature of the cylindrical support member is set within a bending permissible stress of the glass substrate.

7. The image character recording apparatus according to claim 6, wherein the cylindrical support member is a recording drum.

8. The image character recording apparatus according to claim 6, wherein the cylindrical support member is formed with a plurality of discs arranged in an axial direction.
